(19) United States
(12) Patent Application Publication
(10) Pub. No.: US 2013/0344428 A1
(43) Pub. Date: Dec. 26, 2013

(54) POSITIVELY CHARGEABLE MAGNETIC TONER AND IMAGE FORMING METHOD

(71) Applicant: KYOCERA Document Solutions Inc., Osaka-shi (JP)

(72) Inventor: Akinori Koyama, Osaka-shi (JP)

(21) Appl. No.: 13/923,733

(22) Filed: Jun. 21, 2013

(30) Foreign Application Priority Data
Jun. 25, 2012 (JP) 2012-142470

(51) Int. Cl. G03G 9/083

(52) U.S. Cl. CPC G03G 9/0837
USPC 430/106.2; 430/123.3

(57) ABSTRACT

The positively chargeable magnetic toner contains a binder resin and a magnetic powder with a specified octahedral shape, in which a frictional charged amount of the magnetic powder with a ferrite carrier, and a particle number of the magnetic powder exposed on a surface of the positively chargeable magnetic toner per 1 μm² area of the positively chargeable magnetic toner in an electron microscope image, are defined as values within predetermined ranges.

### INCORPORATION BY REFERENCE

This application is based upon and claims the benefit of priority from the corresponding Japanese Patent Application No. 2012-142470, filed in the Japan Patent Office on Jun. 25, 2012, the entire contents of which are incorporated herein by reference.

### FIELD

The present disclosure relates to a positively chargeable magnetic toner and an image forming method.

### BACKGROUND

In general, in electrophotography, the surface of a photoconductor drum is charged by a method such as corona discharge, followed by exposure using a laser etc. to form an electrostatic latent image. The formed electrostatic latent image is developed with a toner so as to from a toner image. The formed toner image is transferred onto a recording medium to obtain an image with high quality. The toner used for formation of a toner image is typically toner particles (toner base particles) with an average particle diameter of 5 μm or larger and 10 μm or smaller produced by mixing a binder resin such as thermoplastic resin with components such as a colorant, a charge control agent and a release agent, followed by a kneading step, a pulverization step and a classification step. For the purpose of providing flowability or suitable charging performance for the toner, and/or for facilitating cleaning of the toner from the surface of the photoconductor drum, silica and/or inorganic fine particles such as those of titanium oxide are externally added to the toner.

A two-component development method using a toner and a carrier such as iron powder, and a magnetic single-component development method using a toner containing magnetic powder inside the toner without using a carrier are known as dry development methods to be employed in various forms of electrophotography which are used in practice.

Toners containing magnetic powder used in the magnetic single-component development method (herein after, also referred to as magnetic toner) have merits including low cost and excellent durability. However, the charged state of the magnetic toner may become unstable under severe environments. When the charged state of the magnetic toner becomes unstable under severe environments, problems mentioned below tend to occur. Under low temperature and low humidity environments, thickness of a thin layer of toner, formed on the developing sleeves of the developing rollers (the surfaces of the developing rollers), are likely to be uneven (layer unevenness), thus image defects may occur in resulting images due to the layer unevenness. Furthermore, images with an intended image density may not be formed under high temperature and high humidity environments.

Thus, a magnetic toner exhibiting a stable charged state even when forming images under severe environments has been proposed in which the magnetic toner contains a binder resin, iron oxide, and a release agent (wax), three specified parameters of the magnetic toner respectively have values within a predetermined range, and the iron oxide is included inside the magnetic toner in a predetermined state. The three specified parameters of the magnetic toner are an average circularity, a ratio of a content of carbon element versus a content of iron element measured using X-ray photoelectron spectroscopy, and a ratio (f/e) of an agglomeration degree (f) after standing under pressure and heating versus an agglomeration degree (e) at ordinary temperatures and pressures.

Incidentally, in previous image forming apparatuses employing a magnetic one-component developing system, the durability of the image forming apparatuse was improved by applying a plating treatment using a metal such as stainless steel and aluminum onto the surface of the developing rollers of the developing units (developing devices). Subsequently, in recent years, in order to further improve the durability of the developing rollers, a plating treatment has been being applied to form a Cr film with a higher hardness onto a surface of the developing rollers.

However, when applying the above-mentioned toner intended to stabilize the charged state under severe environments to image forming apparatuses provided with developing rollers treated with the plating using chrome, although the charged state of the toner may stabilize, a phenomenon in which toner component such as a release agent thinly adhere to a surface of the developing rollers (filming) may occur.

### SUMMARY

The first aspect of the present disclosure is a positively chargeable magnetic toner that includes at least a binder resin and a magnetic powder. A particle shape of the magnetic powder is an octahedron which is a convex polyhedron enclosed by eight triangles. A frictional charged amount of the magnetic powder with a ferrite carrier is −20.3 μC/g or more and −10.2 μC/g or less. A particle number of the magnetic powder, exposed on a surface of the positively chargeable magnetic toner per 1 μm² area of the positively chargeable magnetic toner, is 4 or more and 12 or less in an electron microscope image of the positively chargeable magnetic toner.

Another aspect of the present disclosure is an image forming method of forming an image using the positively chargeable magnetic toner of the first aspect by an image forming apparatus having a developing unit equipped with a developing roller whose surface has been plated with chrome.

### BRIEF DESCRIPTION OF DRAWINGS

FIG. 1 is a view for illustrating a configuration of constructional parts concerning a printer used in the image forming method of the second embodiment of the present disclosure.

### DETAILED DESCRIPTION

Hereinafter, the present disclosure is explained in detail with reference to embodiments thereof. The present disclosure is not limited at all to the embodiments and may be carried out by appropriately making a change within the purpose of the present disclosure. Explanations may be occasionally omitted with respect to duplicated matters but this does not limit the essence of the present disclosure.

### First Embodiment

The first embodiment of the present disclosure relates to the positively chargeable magnetic toner (hereinafter, also simply referred to as “toner”) containing a binder resin and a magnetic powder with a predetermined particle shape. The frictional charged amount of the magnetic powder with ferrite carrier, and the particle number of the magnetic powder exposed on the surface of the positively chargeable magnetic toner per 1 μm² area in an electron microscope image, are values within predetermined ranges. The positively chargeable magnetic toner according to the first embodiment is favorably used in magnetic one-component developing systems.

The toner according to the first embodiment may contain optional components such as a release agent, a colorant, and a charge control agent as required in addition to the binder resin and the magnetic powder. The surface of the toner according to the first embodiment may be treated with an external additive as required. The binder resin, the magnetic powder, the release agent, the colorant, the charge control agent, and the external additive, which are essential or optional components in the toner according to the first embodiment, as well as a method of producing the positively chargeable magnetic toner are explained in order below.

### Binder Resin

The binder resin, which is included in the toner according to the first embodiment, is not particularly limited as long as it is a resin used heretofore for a binder resin as a constituent component of toner particles. Specific examples of the binder resin include thermoplastic resins such as styrene resins, acrylic resins, styrene-acrylic resins, polyethylene resins, polypropylene resins, vinyl chloride resins, polyester resins, polyamide resins, polyurethane resins, polyvinyl alcohol resins, vinyl ether resins, N-vinyl resins, and styrene-butadiene resins. Among these resins, styrene-acrylic resins and polyester resins are preferable in view of chargeability and fixability of the toner to paper. Hereinafter, the styrene-acrylic resin and the polyester resin are explained.

The styrene-acrylic resin is a copolymer of a styrene monomer and an acrylic monomer. Specific examples of the styrene monomer include styrene, α-methylstyrene, vinyl toluene, α-chlorostyrene, o-chlorostyrene, m-chlorostyrene, p-chlorostyrene, and p-ethylstyrene. Specific examples of the acrylic monomer include (meth)acrylic acid alkyl esters such as methyl acrylate, ethyl acrylate, n-propyl acrylate, iso-propyl acrylate, n-butyl acrylate, iso-butyl acrylate, 2-ethylhexyl acrylate, methyl methacrylate, ethyl methacrylate, n-butyl methacrylate, and iso-butyl methacrylate.

The polyester resin may be those obtained from condensation polymerization or condensation copolymerization of a divalent, trivalent or higher-valent alcohol component and a divalent, trivalent or higher-valent carboxylic acid component. The components to be used in synthesizing the polyester resin include alcohol components and carboxylic acid components, which are mentioned below.

Specific examples of the divalent, trivalent or higher-valent alcohols may be exemplified by diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexane dimethanol, dipropylene glycol, polyethylene glycol, polypropylene glycol, and polytetramethylene glycol; bisphenols such as bisphenol A, hydrogenated bisphenol A, polyoxyethylenated bisphenol A, and polyoxypropylenated bisphenol A; and trivalent or higher-valent alcohols such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

Specific examples of the divalent, trivalent or higher-valent carboxylic acids include divalent carboxylic acids such as maleic acid, fumaric acid, citraconic acid, itaconic acid, glutaconic acid, phthalic acid, isophthalic acid, terephthalic acid, cyclohexane dicarboxylic acid, succinic acid, adipic acid, sebacic acid, azelaic acid, malonic acid, or alkyl or alkenyl succinic acids including n-butyl succinic acid, n-butenyl succinic acid, isobutylsuccinic acid, isobutenylsuccinic acid, n-octylsuccinic acid, n-octenylsuccinic acid, n-dodecylsuccinic acid, n-dodecenylsuccinic acid, isododecylsuccinic acid, isododecenylsuccinic acid; and trivalent or higher-valent carboxylic acids such as 1,2,4-benzene tricarboxylic acid (trimellitic acid), 1,2,5-benzene tricarboxylic acid, 2,5,7-naphthalene tricarboxylic acid, 1,2,4-naphthalene tricarboxylic acid, 1,2,4-butane tricarboxylic acid, 1,2,5-hexane tricarboxylic acid, 1,3-dicarboxyl-2-methyl-2-methylene carboxypropane, 1,2,4-cyclohexane tricarboxylic acid, tetra(methylenecarboxyl)methane, 1,2,7,8-octanetetracarboxylic acid, pyromellitic acid, and Enpol trimer. These divalent, trivalent or higher-valent carboxylic acids may be used as ester-forming derivatives such as an acid halide, an acid anhydride, and a lower alkyl ester. Here, the term “lower alkyl” means an alkyl group of from 1 to 6 carbon atoms.

When the binder resin is a polyester resin, the softening temperature of the polyester resin is preferably 80° C. or higher and 150° C. or lower, and more preferably 90° C. or higher and 140° C. or lower.

Thermoplastic resins are preferable as the binder resin since the fixability thereof is good. The thermoplastic resins may be used by adding a cross-linking agent and/or a thermosetting resin rather than solely using the thermoplastic resins. By introducing a partial cross-linked structure into the binder resin, properties of the toner such as storage stability, morphological retention, and durability may be improved without degrading the fixability.

Preferable examples of the thermosetting resin usable in combination with the thermoplastic resin are epoxy resins and cyanate resins. Specific examples of the preferred thermosetting resin may be exemplified by bisphenol-A type epoxy resins, hydrogenated bisphenol-A type epoxy resins, novolac-type epoxy resins, polyalkylene ether-type epoxy resins, cyclic aliphatic-type epoxy resins, and cyanate resins. These thermosetting resins may be used in a combination of two or more.

The glass transition temperature (Tg) of the binder resin is preferably 50° C. or higher and 65° C. or lower, and more preferably 50° C. or higher and 60° C. or lower. When using a toner containing a binder resin having an excessively low glass transition temperature, the toner may self-fuse in the developing unit of an image forming apparatus and/or the toner may partially self-fuse during shipping of toner containers and/or during storage in warehouses due to degradation of storage stability. When using a toner containing a binder resin having an excessively high glass transition temperature, toner images may be resistant to being properly fixed at lower temperatures and/or the toner may tend to adhere to latent image bearing members (photoconductors) due to low strength of the binding resin.

The glass transition temperature of the binder resin may be determined from the change point of the specific heat of the binder resin with a measuring method on the basis of JIS K7121 by using a differential scanning calorimeter (DSC). A more specific measuring method is described below. The glass transition temperature of the binder resin can be measured by measuring the endothermic curve of the binder resin using a differential scanning calorimeter DSC-6200 manufactured by Seiko Instruments Inc. as a measuring device. The sample to be measured (10 mg) is loaded into an aluminum pan and an empty aluminum pan is used as a reference. The glass transition temperature of the binder resin may be determined from the obtained endothermic curve of the binder resin which is obtained through measurement in the measuring temperature range from 25° C. to 200° C., at a temperature-increase rate of 10° C./min, and at normal temperature and normal humidity.

### Magnetic Powder

The toner contains the magnetic powder in the binder resin. The type of the magnetic powder compounded in the binder resin is not particularly limited as long as it has a predetermined particle shape described later and its frictional charged amount with ferrite carrier is within a predetermined range.

The shape of particles of the magnetic powder used for preparing the toner is an octahedron which is a convex polyhedron enclosed by eight triangles. Since the shape of particles of the magnetic powder is octahedral, there are many sharp ridge lines and vertices on the surface of the particles of the magnetic powder. Therefore, when using the magnetic powder having such a particle shape, deposits at the surface of the developing rollers contact the ridge lines and/or vertices of the magnetic powder exposed on the toner surface and thus are polished when the toner moves on the developing rollers, therefore, the occurrence of filming on the surface of the developing rollers can be suppressed.

In contrast, a magnetic powder of which the particle shape is a hexahedron which is a convex polyhedron enclosed by six quadrangles has a smaller number of ridge lines and vertices on the surface of the particles of the magnetic powder compared to the magnetic powder of which the particle shape is octahedral. For this reason, in cases of using a magnetic powder of which particle shape is hexahedral, polishing of the surface of the developing rollers by the magnetic powder exposed on the toner surface is unlikely to be sufficient and thus the occurrence of filming is difficult to suppress, compared to a magnetic powder of which the particle shape is octahedral. Additionally, in cases of using the magnetic powder of which the particle shape is spherical, there are essentially no ridge lines on the surface of the particles of the magnetic powder; therefore, the occurrence of filming can hardly be suppressed.

The material of the magnetic powder is not particularly limited as long as it is capable of producing a magnetic powder of which the particle shape is a predetermined octahedron as described above and the frictional charged amount with a ferrite carrier is within a predetermined range. A preferable material of the magnetic powder may be exemplified by ferrite and magnetite. Particularly, magnetite is preferably used from the viewpoint that the frictional charged amount of the magnetic powder with a ferrite carrier can be easily adjusted within a range −20.3 μC/g or more and −10.2 μC/g and less.

The toner according to the first embodiment of the present disclosure contains a magnetic powder of which the frictional charged amount with a ferrite carrier is from −20.3 μC/g or more and −10.2 μC/g or less. By including such a magnetic powder in the toner, the charged state of the toner can be stabilized even when forming images under severe environments. When the charged state of the toner is stable, images with an intended image density can be formed even when forming images under high temperature and high humidity environments. Furthermore, when the charged state of the toner is stable, a tendency to uneven thickness of toner thin layers carried on developing sleeves can be suppressed under low temperature and low humidity environments.

In cases of forming images using a toner containing a magnetic powder of which the frictional charged amount with a ferrite carrier is greater than −10.2 μC/g, the charged state of the toner tends to become unstable when forming images under low temperature and low humidity environments. When the charged state of the toner becomes unstable under low temperature and low humidity environments, the thickness of toner thin layers carried on the developing sleeves or on the surface of the developing rollers tends to become uneven. In cases of forming images using a toner containing a magnetic powder of which the frictional charged amount with a ferrite carrier is less than −20.3 μC/g, the charged state of the toner tends to become unstable when forming images under high temperature and high humidity environments. When the charged state of the toner becomes unstable under high temperature and high humidity environments, images with an intended image density may not be formed.

The method of producing the magnetic powder is not particularly limited as long as the resulting magnetic powder exhibits a frictional charged amount with a ferrite carrier within a predetermined range. The magnetic powder exhibiting a frictional charged amount with a ferrite carrier of −20.3 μC/g or more and −10.2 μC/g or less can be produced by the method below in the case of using magnetite as the magnetic powder.

The frictional charged amount of the magnetic powder with a ferrite carrier can be measured in accordance with the method below.

Method of Measuring a Frictional Charged Amount with a Ferrite Carrier

10 g of non-coated ferrite carrier with an average particle diameter of 80 μm (F-80, by Powder Tech K. K.) and 0.3 g of the magnetic powder are poured into a plastic container of volume 20 mL. Then, the non-coated ferrite carrier and the magnetic powder in the plastic container are stirred for 60 minutes using a Turbula mixer. Thereafter, a charged amount of the magnetic powder is measured using the stirred mixture of the non-coat ferrite carrier and the magnetic powder as a sample and the resulting measured value is defined as a frictional charged amount of the magnetic powder with a ferrite carrier. A suction-type charged amount meter (210HS-2A, by Trek, Inc.) may be used as the device for measuring a charged amount.

Hereinafter, the production of magnetite particles is explained in terms of a preferable specific example of the method of producing the magnetic powder of which the particle shape is octahedral and the frictional charged amount with a ferrite carrier is within a predetermined range. Here, the method of producing the magnetic powder of which the particle shape is octahedral and the frictional charged amount with a ferrite carrier is within a predetermined range is not limited to the method explained below.

### (Production Method of Magnetic Powder)

An aqueous sodium phosphate solution and an aqueous alkaline solution are added to an aqueous ferrous salt solution. The mixture solution is heated to a temperature of 80° C. or higher to obtain a suspension containing an iron hydroxide collide. Then, the pH of the suspension is adjusted to 10 or higher while maintaining the temperature of the resulting suspension. An oxygen-containing gas such as air is aerated into the pH-adjusted suspension while adding an aqueous phosphoric acid solution thereto to cause an oxidation reaction, thereby obtaining a slurry containing magnetite particles. Then, the magnetite particles are separated from the slurry containing the magnetite particles by filtering. The separated magnetite particles are rinsed with water and dried to obtain an agglomeration of the magnetite particles. The resulting agglomeration of the magnetite particles is crushed to thereby obtain the magnetic powder.

The frictional charged amount with a ferrite carrier of the magnetite produced by the above-mentioned method can be adjusted by controlling the amount of sodium phosphate used, for example. As the amount of sodium phosphate used becomes larger, the frictional charged amount of the magnetite with the ferrite carrier becomes larger.

By adjusting the pH during the oxidation reaction to 10 or higher in the above-mentioned method, octahedral magnetite particles which are convex polyhedrons enclosed by eight triangles can be prepared. When performing the oxidation reaction at a pH within a range from about 8 to 9, hexahedral magnetite particles which are convex polyhedrons enclosed by six quadrangles are inevitably produced. Moreover, when performing the oxidation reaction at a pH of 6 or lower, spherical magnetite particles are inevitably produced. The particle shape of the magnetic powder can be confirmed from a photograph (magnification: 10,000 times or more) taken using a scanning electron microscope (SEM).

The particle diameter of the magnetic powder is preferably 0.16 μm or larger and 0.25 μm or smaller. In cases of using the magnetic powder having a particle diameter within this range, the magnetic powder may be easily uniformly dispersed into the binder resin; therefore, the particle number of the magnetic powder observed in an electron microscope image may be easily controlled to the range from 4 to 12 per 1 μm² area of the toner. Hereinafter, the particle number of the magnetic powder per 1 μm² area of the toner, observed in an electron microscope image, is also simply referred to as the “number of exposed particles in the magnetic powder (number/μm²)”. The above-mentioned frictional charged amount of the magnetic powder with a ferrite carrier can also be adjusted by adjusting a particle diameter of the magnetic powder. As the particle diameter of the magnetic powder becomes smaller, the above-mentioned frictional charged amount of the magnetic powder with the ferrite carrier becomes larger.

When preparing a toner using a magnetic powder with an excessively small particle diameter, the number of exposed particles in the magnetic powder (number/μm²) tends to be excessively small. In cases of using a toner with a small number of exposed particles in the magnetic powder (number/μm²), polishing of the surface of the developing rollers is likely to be insufficient and thus it is difficult to suppress occurrence of filming. On the other hand, when preparing a toner using a magnetic powder with an excessively large particle diameter, the number of exposed particles in the magnetic powder (number/μm²) tends to be excessively large. In this case, charge leakage tends to occur from the ridge lines and/or vertices of magnetic particles exposed on the toner surface, and the charged state of the toner tends to become unstable under high temperature and high humidity environments in particular. When the charged state of the toner is unstable under high temperature and high humidity environments, it is difficult to form images with a desired image density.

The average particle diameter of the magnetic powder can be measured using an image magnified a further 4 times from an image taken at a magnification of 10,000 times using a transmission electron microscope. Specifically, 300 particles at random of the magnetic powder in an electron microscope image are measured for a Martin diameter (equivalent circle diameter) and an average value of the Martin diameters of the 300 particles of the magnetic powder is calculated, thereby the average particle diameter of the magnetic powder can be determined. The particle diameter of the magnetic powder with an octahedral particle shape can be controlled by changing the production conditions in accordance with conventional methods. In cases of preparing the magnetic powder with an octahedral particle shape consisting of magnetite, the particle diameter can be adjusted by adjusting the time of the oxidation reaction when performing the above-mentioned production method.

In order to improve dispersibility of the magnetic powder into the binder resin, magnetic powder surface-treated by a surface treatment agent such as a titanium coupling agent and a silane coupling agent may also be used.

The amount of the magnetic powder used is preferably 35 parts by mass or more and 60 parts by mass or less, and more preferably 40 parts by mass or more and 50 parts by mass or less based on 100 parts by mass of the total amount of the toner. When using such an amount of the magnetic powder, the number of exposed particles in the magnetic powder (number/μm²) may be easily adjusted within the range from 4 to 12. Additionally, the number of exposed particles in the magnetic powder (number/μm²) depends on the amount of the magnetic powder used. For this reason, the amount of the magnetic powder used is appropriately increased or decreased so that the number of exposed particles in the magnetic powder (number/μm²) is a value within a predetermined range.

### Release Agent

The toner may contain a release agent in order to improve fixability of the toner to recording media and/or to suppress occurrence of offset due to fusion of the toner to fixing rollers. Preferably, the toner according to the first embodiment includes the release agent. The release agent to be added to the toner is preferably wax. Specific examples of the wax include polyethylene wax, polypropylene wax, fluorocarbon resin wax, Fischer-Tropsch wax, paraffin wax, ester wax, montan wax, and rice wax. These release agents may be used in a combination of two or more kinds thereof. Addition of these release agents to the toner permits efficient suppressing of offset or image smearing (dirt occurring in the periphery of the image when images are rubbed).

The specific amount of the release agent used is preferably from 2 parts by mass or more and 10 parts by mass or less based on 100 parts by mass of the binder resin. When using a toner prepared using the release agent in an excessively small amount, it is difficult to obtain an intended effect for suppressing the occurrence of offset and/or image smearing in the resulting images. When using a toner prepared using the release agent in an excessively large amount, the storage stability of the toner may be poor since the toner itself tends to fuse.

Average particle diameter (hereinafter, also referred to as “DW_{AV}”) of particles of the release agent dispersed in the binder resin is preferably 0.5 μm or smaller, more preferably 0.4 μm or smaller, particularly preferably 0.3 μm or smaller, and most preferably 0.1 μm or larger to 0.3 μm or smaller. In the toner of which the DW_{AV} is within this range, it is easy to suppress the occurrence of offset. Furthermore, in cases where the DW_{AV} is within this range, it is easy to suppress the occurrence of filming on the surface of the developing rollers when forming images for a long period.

DW_{AV} can be measured by the method below.

### Method of Measuring DW_{AV}

A sample where a toner has been embedded in a resin is prepared. Using a microtome, a thin-piece sample of 200 nm thick for observing a cross-section of the toner is prepared from the resulting sample. The resulting thin-piece sample is observed using a transmission electron microscope (TEM) at a magnification from 10,000 to 30,000 times; and among particles of the release agent dispersed in the binder resin, images of randomly selected 100 particles of the release agent are taken to measure particle diameters thereof. The taken images are analyzed by an image analysis software (WINROOF, by Mitani Co.), and a Martin diameter (equivalent circle diameter) of particles to be measured is defined as a particle diameter of the release agent. An average value of particle diameters of the 100 particles of the release agent to be measured is defined as DW_{AV}.

When a toner is produced by melting and kneading components of the toner followed by pulverizing thereof, the particle diameter of the release agent dispersed in the binder resin can be controlled by appropriately changing the condition of melting and kneading. The particle diameter of particles of the release agent in the binder resin can be reduced by changing a pattern of a screw of a melting/kneading device into a pattern with a higher kneading effect. On the other hand, the particle diameter of particles of the release agent in the binder resin can be enlarged by changing a pattern of a screw of the melting/kneading device into a pattern with a lower kneading effect. Furthermore, the particle diameter of particles of the release agent in the binder resin can be reduced by lowering a cylinder temperature of the melting/kneading device during melting and kneading. On the other hand, the particle diameter of particles of the release agent in the binder resin can be enlarged by raising the cylinder temperature of the melting/kneading device during melting and kneading. The reason is that as the cylinder temperature becomes higher, the mixture in the melting/kneading device becomes softer, and thus shear force is less likely to act on the mixture in the device.

In the above-mentioned measurement method, a microtome such as Leica Ultracut S (by Leica Co.) and a transmission electron microscope such as JSM-7600 (by JEOL Ltd.) can be used.

### Colorant

The toner contains the magnetic powder as an essential component and thus is typically black. Conventional dyes or pigments may be included as a colorant in order to tailor the resulting images, formed using the one-component magnetic developer of the present disclosure, into a more preferable black hue. Specifically, carbon black may be exemplified as a pigment, and acid violet may be exemplified as a dye.

The amount of the colorant used is preferably 1 part by mass or more and 20 parts by mass or less, and more preferably 1 part by mass or more and 10 parts by mass or less based on 100 parts by mass of the binder resin.

### Charge Control Agent

The toner may contain a charge control agent in the binder resin. The charge control agent is used for the purpose of improving a charged level of the toner and/or a charge-increasing property which is an indicator of chargeability to a predetermined charged level within a short period, thereby obtaining a toner with excellent durability and stability. The toner according to the first embodiment is a positively chargeable toner and thus a positively chargeable charge control agent is used.

The type of the positively chargeable charge control agent may be appropriately selected from conventional charge control agents used for toners heretofore. Specific examples of the positively-chargeable charge control agent are azine compounds such as pyridazine, pyrimidine, pyrazine, ortho-oxazine, meta-oxazine, para-oxazine, ortho-thiazine, meta-thiazine, para-thiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; direct dyes consisting of azine compounds such as azine Fast Red FC, azine Fast Red 12BK, azine Violet BO, azine Brown 3G, azine Light Brown GR, azine Dark Green BH/C, azine Deep Black EW, and azine Deep Black 3RL; nigrosine compounds such as nigrosine, nigrosine salts, and nigrosine derivatives; acid dyes consisting of nigrosine compounds such as nigrosine BK, nigrosine NB, and nigrosine Z; metal salts of naphthenic acid or higher fatty acid; alkoxylated amines; alkylamides; quaternary ammonium salts such as benzylmethylhexyldecyl ammonium, and decyltrimethylammonium chloride. Among these positively-chargeable charge control agents, nigrosine compounds are particularly preferable from the viewpoint that a rapid charge rising property can be obtained. These positively-chargeable charge control agents may be used in a combination of two or more.

In addition, resins having a quaternary ammonium salt, a carboxylic acid salt, or a carboxyl group as a functional group may be used for the positively-chargeable charge control agent. More specifically, styrene resins having a quaternary ammonium salt, acrylic resins having a quaternary ammonium salt, styrene-acrylic resins having a quaternary ammonium salt, polyester resins having a quaternary ammonium salt, styrene resins having a carboxylic acid salt, acrylic resins having a carboxylic acid salt, styrene-acrylic resins having a carboxylic acid salt, polyester resins having a carboxylic acid salt, styrene resins having a carboxyl group, acrylic resins having a carboxyl group, styrene-acrylic resins having a carboxyl group, and polyester resins having a carboxyl group may be exemplified. These resins may be oligomers or polymers.

Among the resins usable as the positively-chargeable charge control agent, styrene-acrylic resins having a quaternary ammonium salt as the functional group are more preferable since the charged amount may be easily controlled within a desired range. In regards to the styrene-acrylic resins having a quaternary ammonium salt as the functional group, specific examples of acrylic co-monomers preferably copolymerized with a styrene unit may be exemplified by (meth)acrylic acid alkyl esters such as methyl acrylate, ethyl acrylate, n-propyl acrylate, iso-propyl acrylate, n-butyl acrylate, iso-butyl acrylate, 2-ethylhexyl acrylate, methyl methacrylate, ethyl methacrylate, n-butyl methacrylate, and iso-butyl methacrylate.

The units derived from dialkylamino alkyl(meth)acrylates, dialkyl(meth)acrylamides, or dialkylamino alkyl(meth)acrylamides through a quaternizing step may be used as the quaternary ammonium salt. Specific examples of the dialkylamino alkyl(meth)acrylate include dimethylamino ethyl(meth)acrylate, diethylamino ethyl(meth)acrylate, dipropylamino ethyl(meth)acrylate, and dibutylamino ethyl(meth)acrylate; a specific example of the dialkyl(meth)acrylamide is dimethyl methacrylamide; and a specific example of the dialkylamino alkyl(meth)acrylamide is dimethylamino propylmethacrylamide. Hydroxyl group-containing polymerizable monomers such as hydroxy ethyl(meth)acrylate, hydroxy propyl(meth)acrylate, 2-hydroxy butyl(meth)acrylate, and N-methylol (meth)acrylamide may be used in combination at the time of polymerization.

The amount of the positively chargeable charge control agent used is preferably 1.5 parts by mass or more and 15 parts by mass or less, more preferably 2.0 parts by mass or more and 8.0 parts by mass or less, and particularly preferably 3.0 parts by mass or more and 7.0 parts by mass or less based on 100 parts by mass of the total amount of the toner. When forming images using a toner where the content of the charge control agent is excessively small, image density of the resulting images may be lower or it may become difficult to maintain image density for a long period since it is difficult to stably charge the toner to an intended charged amount. Furthermore, in a toner where the content of the charge control agent is excessively small, it is difficult to uniformly disperse the charge control agent in the binder resin. When forming images using a toner where the charge control agent is nonuniformly dispersed in the binder resin, fog may occur in the resulting images and/or latent image bearing members may be smeared by the toner. When forming images using a toner where the amount of the charge control agent used is excessively large, degradation of environmental resistance of the toner may cause inferior charge of the toner under high temperature and high humidity environments, then image defects may occur in resulting images and/or latent image bearing members may be smeared by the toner.

### External Additive

In the toner according to the first embodiment, an external additive may be attached to a surface of toner particles as required. Here, the particles to be treated using the external additive is referred to as “toner base particles”. The type of the external additive may be appropriately selected from conventional external additives used for toners heretofore. Specific examples of the preferable external additive may be exemplified by silica and metal oxides such as alumina, titanium oxide, magnesium oxide, zinc oxide, strontium titanate, and barium titanate. These external additives may be used in a combination of two or more. These external additives may be used in a state in which they are made to be hydrophobic with the use of hydrophobic agents such as aminosilane coupling agent and/or silicone oil can be used. When external additives which are made to be hydrophobic are used, it is possible to easily obtain toners in which a decrease in the charged amount of toner at a high temperature and high humidity is easily suppressed and which have excellent flowability.

When attaching the external additive to a surface of toner particles, an area ratio of external additive/toner (Ae/At (%)) is preferably 30% or higher and 60% or lower, in which the area ratio (%) is an area (Ae) of the external additive attaching to a surface of toner particles versus an area (At) of toner particles in an electron microscope image. When using the external additive in an amount that the area ratio of external additive/toner (Ae/At (%)) is within this range, certain effects by use of the external additive may be obtainable, without inhibiting the above-mentioned effect of polishing the surface of developing rollers, derived from the magnetic powder with an octahedral particle shape exposed on the surface of the toner. The area ratio of external additive/toner (Ae/At (%)) is an indicator of a level in which the surface of toner particles is coated with the external additive. The area ratio of external additive/toner (Ae/At (%)) can be measured in accordance with the method below.

### Method of Measuring Area Ratio of External Additive/Toner (%)

A secondary electron photographic image (SEM image, magnification: 30,000 times) of toner particles is taken using a scanning electron microscope (SEM). The taken SEM image is binarized using an image analysis software, and 100 toner particles are respectively measured in the SEM image for an area (At) of a toner particle and an area (Ae) of the external additive attaching to a surface of the toner particle, and then the ratio (Ae/At (%)) of the area (Ae) of the external additive versus the area (At) of the toner particle is calculated. An average value of Ae/At (%) obtained respectively for 100 toner particles is defined as the area ratio (%) of external additive/toner of the toner as a measurement sample.

JSM-7600 (by Jeol Ltd.) is exemplified as a scanning electron microscope usable in the above-mentioned method. WINROOF (by Mitani Co.) is exemplified as an image analysis software usable in the above-mentioned method.

Particle diameter of the external additive is preferably from 0.01 μm to 1.0 μm

The amount of the external additive used is preferably 0.1 part by mass or more and 10 parts by mass or less, and more preferably 0.2 part by mass or more and 5 parts by mass or less based on 100 parts by mass of toner particles prior to the external treatment. It is also preferred, in cases of using the external additive in such an amount, that the amount of the external additive used is adjusted so that the area ratio of external additive/toner (%) is within the range described above.

### Method of Producing Positively Chargeable Magnetic Toner

Hereinafter, the method of producing the toner according to the first embodiment of the present disclosure is explained.

The method of producing the toner according to the first embodiment of the present disclosure may be appropriately selected from conventional methods of producing a toner without particular limitation thereto as long as capable of properly dispersing the magnetic powder and other optional components in the binder resin while exposing the magnetic powder on the surface of toner particles under a predetermined state. A preferable production method may be exemplified by a method of mixing a mixture of the binder resin and the magnetic powder with optional components such as a release agent as required, then the resulting mixture is melted and kneaded, followed by pulverizing and classifying the melt-kneaded material. The melting/kneading device used for producing the toner may be appropriately selected from those used for melting and kneading thermoplastic resins without particular limitation thereto. Specific examples of the melting/kneading device include single or twin screw extruders. Average particle diameter of the toner is preferably 5 μm or larger and 10 μm or smaller.

The toner resulting from this way may be surface-treated using an external additive as required. The method of treating the toner using an external additive may be appropriately selected from conventional treatment methods that use an external additive. Specifically, treatment conditions are adjusted so that particles of the external additive are not embedded into toner base particles and then treatment using the external additive is performed using a mixer such as HENSCHEL MIXER and NAUTER MIXER.

In the toner according to the first embodiment, the particle number of the magnetic powder exposed per 1 μm² area of the toner (number of exposed particles in the magnetic powder (number/μm²)) observed in an electron microscope image is 4 or more and 12 or less. The number of exposed particles in the magnetic powder (number/μm²) can be adjusted by controlling the particle diameter of the magnetic powder.

The number of exposed particles in the magnetic powder (number/μm²) can be measured in accordance with the method below.

Method of Measuring Number of Exposed Particles in Magnetic Powder (number/μm²)

A secondary electron photographic image (SEM image, magnification: 30,000 times) of toner particles is taken using a scanning electron microscope (SEM). The taken SEM image is binarized using the image analysis software (WINROOF, by Mitani Co.). 100 toner particles at random in the binarized SEM image are respectively measured for an area (At (μm²)) of each toner particle in the SEM image. The 100 toner particles, measured for an area (At) of each toner particle, are respectively measured for a particle number (Nm) of the magnetic powder exposed on a surface of each toner particle. For each of the 100 toner particles, Nm (number)/At (μm²) is calculated from At (μm²) and Nm (number), respectively. An average value of Nm (number)/At (μm²) of the 100 toner particles is defined as a particle number of the magnetic powder exposed on toner surface per 1 μm² area of the toner in an electron microscope image (number of exposed particles in magnetic powder (number/μm²)).

Examples of the scanning electron microscope and the image analysis software usable in the above-mentioned method may be similar to those usable for the method of measuring the area ratio (%) of external additive/toner.

When observing the toner treated with an external additive using only SEM alone, it may be difficult to distinguish between the magnetic powder exposed on a toner surface and the external additive coating on a toner surface. In such a case, by performing elemental analysis of the toner surface using an energy dispersive X-ray analyzer (EDX) together with the observation using SEM, the number of exposed particles in the magnetic powder (number/μm²) can be measured while distinguishing the magnetic powder and the external additive.

JED-2100 (by Jeol Ltd.) may be exemplified as an energy dispersive X-ray analyzer (EDX) usable in the above-mentioned method.

By use of the toner according to the first embodiment of the present disclosure, occurrence of filming can be suppressed, images with an intended image density can be formed even under high temperature and high humidity environments, and tendency to uneven thickness of toner thin layers carried on developing sleeves can be suppressed under low temperature and low humidity environments. Accordingly, the toner according to the first embodiment may be favorably used for various image forming apparatuses.

### Second Embodiment

The second embodiment of the present disclosure relates to an image forming method in which images are formed using the positively chargeable magnetic toner according to the first embodiment by using an image forming apparatus having a developing unit where a developing roller is provided thereto and chromizing is applied on a surface of the developing roller. Hereinafter, the image forming method according to the second embodiment of the present disclosure is explained.

The image forming apparatus used in the image forming method according to the second embodiment is not particularly limited thereto as long as a positively chargeable magnetic toner can be used as a developer, a developing unit is provided thereto and a developing roller is provided to the developing unit, and chromizing is applied on a surface of the developing roller. Preferably, a monochrome toner, which is usually black, is used in the image forming apparatus since the toner of the first embodiment is typically black. Here, an image forming method is explained in which an image forming apparatus using a monochrome toner is used.

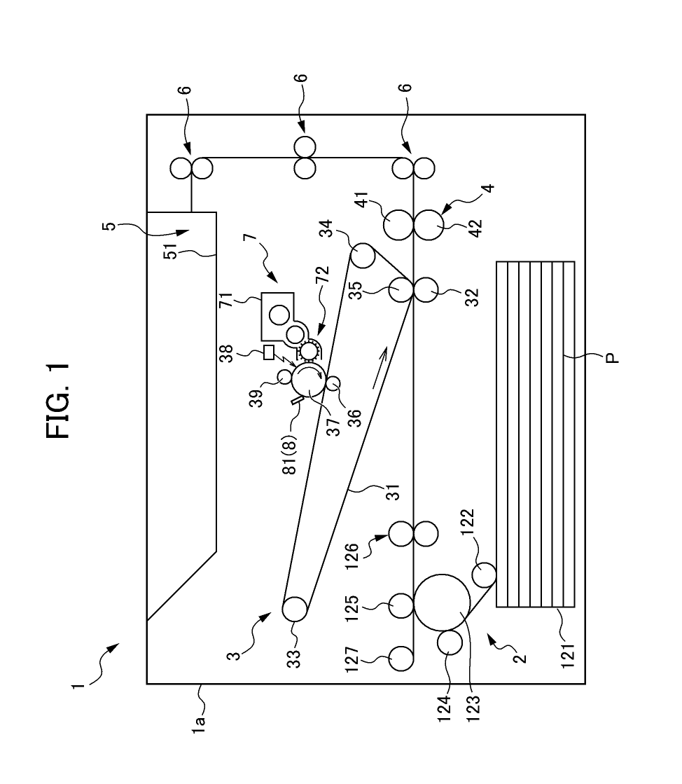

FIG. 1 is a view illustrating a configuration of a preferable image forming apparatus. Here, a monochrome printer 1 is explained as an example of the image forming apparatus.

The monochrome printer 1 has a box-type device body 1a as shown in FIG. 1. A paper feed unit 2 that feeds a paper P, an image forming unit 3 that transfers a toner image based on image data on the paper P while conveying the paper P fed from the paper feed unit 2, and a fixing unit 4 that applies a fixing treatment to fix an unfixed toner image transferred on the paper P by the image forming unit 3 to the paper P are provided in the device body 1a. A paper discharge unit 5, to which the paper P, applied with the fixture treatment by the fixing unit 4, is discharged, is further provided at an upper side of the device body 1a.

The paper feed unit 2 is equipped with a paper feed cassette 121, a pick-up roller 122, paper feed rollers 123, 124, 125, and a pair of resist rollers 126. The paper feed cassette 121 is provided detachably to the device body 1a and accommodates the paper P. The pick-up roller 122 is provided at a position of upper left of the paper feed cassette 121 as shown in FIG. 1 to pick up the paper P accommodated in the paper feed cassette 121 one by one. The paper feed rollers 123, 124, 125 send the paper P picked up by the pick-up roller 122 to a paper conveying path. The pair of resist rollers 126 direct the paper P sent to the paper conveying path by the paper feed rollers 123, 124, 125 to temporally wait and feed it to the image forming unit 3 at a predetermined timing.

The paper feed unit 2 is further equipped with a manual feed tray (not shown) attached at left side of the device body 1a shown in FIG. 1 and a pick-up roller 127. The pick-up roller 127 picks up the paper P disposed on the manual feed tray. The paper P picked up by the pick-up roller 127 is sent to a paper conveying path by the paper feed rollers 123, 125 and fed to the image forming unit 3 by the pair of resist rollers 126 at a predetermined timing.

The image forming unit 3 is equipped with an image forming part 7, an intermediate transfer belt 31 to which surface (contact side) a toner image based on image data telephotographed from computers is primarily transferred by the image forming part 7, and a secondary transfer roller 32 that secondarily transfers the toner image on the intermediate transfer belt 31 to the paper P sent from the paper feed cassette 121.

In the image forming part 7, a drum-shaped latent image bearing member 37 as an image carrying member is disposed rotatably along the arrow direction (clockwise direction) at a central position thereof. Furthermore, a charging unit 39, an exposure unit 38, a developing unit 71, a cleaning unit 8, and a neutralization unit (not shown) are disposed around the latent image bearing member 37 in series from an upper stream side of the rotating direction of the latent image bearing member 37.

The charging unit 39 uniformly charges the circumference of the latent image bearing member 37 which is being rotated in the arrow direction. The charging unit 39 is not particularly limited as long as it can uniformly charge the circumference of the latent image bearing member 37 and may be of non-contact or contact type. Specific examples of the charging unit include corona-charging devices, charging rollers, and charging brushes.

Considering the balance between the developing property and the charging capacity of the latent image bearing member 37, the surface potential (charged potential) of the latent image bearing member 37 is preferably from 200 V to 700 V and more preferably from 300 V to 400 V. When the surface potential is excessively low, the development field becomes insufficient and thus it becomes difficult to assure the image density of resulting images. When the surface potential is excessively high, problems such as insufficient charging capacity, insulation breakdown at the latent image bearing member 37, and an increase of ozone amount are likely to occur depending on a thickness of the photosensitive layer.

The latent image bearing member 37 may be exemplified by inorganic photoconductors such as of amorphous silicon and organic photoconductors where a mono-layer or laminated photoconductive layer containing components such as a charge generating agent, a charge transporting agent, and a binder resin is formed on a conductive substrate.

The exposure unit 38 is a so-called laser scanning unit. In the exposure unit 38, laser light is irradiated based on image data input from a personal computer (PC) as a higher-level device to the circumference of the latent image bearing member 37 uniformly charged by the charging unit 39, thereby an electrostatic latent image is formed on the latent image bearing member 37 based on the image data.

In the developing unit 71, the toner according to the first embodiment is supplied to the circumference of the latent image bearing member 37 where the electrostatic latent image has been formed, thereby forming a toner image based on image data. The developing unit 71 is equipped with a stirrer (not shown), a developing roller 72, and a regulating blade (not shown) for regulating a layer thickness of a developer layer formed on a surface of the developing roller 72. The developing roller 72 is constructed from a magnet roller (not shown) and a developing sleeve placed so as to cover an outer circumference of the magnet roller. The magnet roller, into which one or more magnetic poles have been embedded, is formed into a cylindrical shape.

In the developing unit 71, the charged developer (toner) which has been stirred by the stirrer is supplied to the developing roller 72. The toner supplied to the surface of the developing roller 72 is attached to the surface of the developing roller 72 and then is contacted and slid with the regulating blade to thereby form a developer layer with a regulated layer thickness. The toner is transferred from the developer layer formed in this way onto an electrostatic latent image on a surface of the latent image bearing member 37 to thereby form a toner image.

In the image forming method according to the second embodiment, an image forming apparatus (printer 1) is used, and the printer 1 is provided with the developing unit 71 which is provided with the developing roller 72 on which surface chromizing has been applied. The developing roller 72, on which surface chromizing has been applied, is excellent in durability; on the other hand, when using the image forming apparatus having the developing unit 71 equipped with such a developing roller 72, a phenomenon tends to occur such that toner components including a release agent thinly adheres to a surface of the developing roller 72 (filming). However, the toner used as the developer in the image forming method according to the second embodiment is such that the magnetic powder of a certain octahedral shape having many sharp ridge lines and/or vertices on its surface is exposed on a surface of the toner in a predetermined state; therefore, when the toner moves on the surface of development roller 72, the surface of development roller 72 contacts the ridge lines and/or vertices of the magnetic powder exposed on the surface of the toner and thus is polished. For this reason, in the image forming method according to the second embodiment, occurrence of the filming is suppressed regardless of using the image forming apparatus with the developing unit 71 which is provided with the developing roller 72 on which surface is plated with chrome.

In regards to the method of plating using chrome on a surface of the developing roller 72, preferably, a chrome layer is formed using an electroplating process since a uniform plating layer may be easily formed. Thickness of the chrome plating layer on the surface of the developing roller 72 is preferably 1 μm or thicker and 15 μm or thinner.

The toner image formed on a circumference of the latent image bearing member 37 by the developing unit 71 is primarily transferred on the intermediate transfer belt 31. After completing the primary transfer of the toner image to the intermediate transfer belt 31, the toner remaining on the circumference of the latent image bearing member 37 is cleaned by the cleaning unit 8. The cleaning device provided to the cleaning unit 8 is not particularly limited thereto; here, the cleaning unit 8 equipped with an elastic blade 81 as a cleaning device is explained. The elastic blade 81, provided to the cleaning unit 8, removes the toner remaining on the circumference of the latent image bearing member 37 by sliding and rubbing a surface of the latent image bearing member 37. The elastic blade 81 is preferably formed of urethane rubbers or ethylene-propylene rubbers.

The neutralization unit eliminates the charge at the circumference of the latent image bearing member 37 after the primary transfer. The circumference of the latent image bearing member 37, which has been subjected to the cleaning treatment by the cleaning unit 8 and the neutralization unit, proceeds to the charging unit 39 for fresh charging treatment and is subjected to the fresh charging treatment.

The intermediate transfer belt 31 is an endless belt-shaped rotator and is tensioned over a plurality of rollers such as a driving roller 33, a driven roller 34, a backup roller 35, and a primary transfer roller 36 such that its surface side (contact surface) contacts the circumference of the latent image bearing member 37. Furthermore, the intermediate transfer belt 31 is configured such that it rotates endlessly by two or more rollers under the condition of being pressed toward the latent image bearing member 37 by the primary transfer roller 36 disposed oppositely to the latent image bearing member 37. The driving roller 33 is rotatably driven by a driving source such as a stepping motor (not shown) and provides the intermediate transfer belt 31 with a driving force for endless rotation. The driven roller 34, the backup roller 35, and the primary transfer rollers 36 are disposed rotatably and driven to rotate by following the endless rotation of the intermediate transfer belt 31. The rollers 34, 35, 36 are driven to rotate depending on the mover rotation of the driving roller 33 through the intermediate transfer belt 31 and also support the intermediate transfer belt 31.

The primary transfer roller 36 applies a primary transfer bias to the intermediate transfer belt 31. Consequently, the toner image formed on the latent image bearing member 37 is transferred in order (primary transfer) between the latent image bearing member 37 and the primary transfer roller 36 on the intermediate transfer belt 31 that is running around along the arrow direction (counterclockwise).

The secondary transfer roller 32 applies a secondary transfer bias to the paper P. Consequently, the toner image primarily transferred on the intermediate transfer belt 31 is secondarily transferred on the paper P between the secondary transfer roller 32 and the backup roller 35; thereby an unfixed toner image is transferred on the paper P.

The fixing unit 4 applies a fixing treatment to the unfixed toner image transferred on the paper P by the image forming unit 3. The fixing unit 4 is equipped with a heating roller 41 heated by an energizing heater and a pressure roller 42 which is disposed oppositely to the heating roller 41 and of which circumference is urged to contact the circumference of the heating roller 41.

Then, the unfixed toner image, which has been transferred on the paper P by the secondary transfer roller 32 in the image forming unit 3, is fixed on the paper P by the fixture treatment of heating and pressing while the paper P is passing between the heating roller 41 and the pressure roller 42. Then, the fixture-treated paper P is discharged to the paper discharge unit 5. Furthermore, in the monochrome printer 1 of this embodiment, two or more pairs of convey rollers 6 are placed at appropriate sites between the fixing unit 4 and the paper discharge unit 5.

The paper discharge unit 5 is formed by making a concave area at the top of the device body 1a of the monochrome printer 1, and a discharged paper tray 51 to receive the discharged paper P is formed at the bottom of the concave area.

The monochrome printer 1 forms an image on the paper P by the action for forming an image described above. As a result, by forming images using the toner according to the first embodiment in the image forming method according to the second embodiment, occurrence of filming can be suppressed, images with an intended image density can be formed even under high temperature and high humidity environments, and tendency to uneven thickness of toner thin layers carried on developing sleeves can be suppressed under low temperature and low humidity environments.

### EXAMPLES

The present disclosure is explained more specifically with reference to examples below. In addition, the present disclosure is not limited at all to the extent of the examples.

### Preparation Example 1

### Preparation of Magnetic Powders A to I

Magnetic powders A to I described in Table 1 were prepared in accordance with the method below.

Initially, 50 L of an aqueous ferrous sulfate salt solution containing 2.0 mol/L of Fe²⁺, 40.0 L of an aqueous sodium hydroxide solution of 5.0 mol/L, and 10 L of an aqueous sodium phosphate solution in the concentrations described in Table 1 were added to a reaction container and mixed therein. The mixtures in the reaction container were heated to 85° C., thereby yielding ferrous salt suspensions containing a ferrous hydroxide colloid.

The pHs of the suspensions were adjusted at the same temperature to the values described in Table 1. Then, oxidation reaction was initiated by blowing 20 L/min of air into the suspensions. After a reaction rate of the oxidation reaction of ferrous salt had proceeded to 10%, addition of an aqueous phosphoric acid solution dissolving 50 g of orthophosphoric acid in 5 L of water into the reaction container was initiated at an addition rate of 2.5 L/hr. The oxidation reaction was continued for a predetermined period while adding the aqueous phosphoric acid solution to thereby obtain slurries containing magnetite particles. Here, the oxidation reaction was performed so that a total necessary period of the oxidation reaction came to the period described in Table 1.

Magnetite particles were separated from the slurries containing the magnetite particles by filtering in the usual manner. The separated magnetite particles were rinsed and dried and then crushed, thereby obtaining the magnetic powders A to K with the shape and the average particle diameter described in Table 1.

An average particle diameter of the magnetic powders (magnetite particles) was measured using an image magnified a further 4 times from an image taken at a magnification of 10,000 times using a scanning electron microscope (JSM-7600, by Jeol Ltd.). Specifically, 300 particles at random of a magnetic powder on an electron microscope image were measured for a Martin diameter (equivalent circle diameter) and an average value of Martin diameters of 300 particles of the magnetic powder was calculated, thereby the average particle diameter of the magnetic powder was determined.

Furthermore, the particle shape of the magnetic powders A to K was confirmed from a photograph (magnification: 10,000 to 50,000 times) taken using a scanning electron microscope (JSM-7600, by Jeol Ltd.). The particle shape of the magnetic powder J was a hexahedron of convex polyhedron enclosed by six quadrangles; and the particle shape of the magnetic powder K was spherical.

The resulting magnetic powders A to K were measured for an average particle diameter and a frictional charged amount with ferrite carrier in accordance with the methods below. Measurement results of the average particle diameter and the frictional charged amount of the magnetic powders are shown in Table 1.

### Method of Measuring Average Particle Diameter

Using a magnetic powder dispersion dispersing a magnetic powder in water as a sample, an average particle diameter of the magnetic powder was measured by a particle size distribution analyzer (LA-700, by Horiba Ltd.).

Method of Measuring Frictional Charged Amount with Ferrite Carrier

10 g of non-coat ferrite carrier with average particle diameter 80 μm (F-80, by Powder Tech Co.) and 0.3 g of a magnetic powder were poured into a plastic container of volume 20 mL (wide-mouth bottle, by Mizuho Chemical Ind.). Then, the non-coat ferrite carrier and the magnetic powder in the plastic container were stirred for 60 minutes using a Turbula mixer (T2F, by Shinmaru Enterprise Co.). Thereafter, a frictional charged amount of the magnetic powder with ferrite carrier was measured using the stirred mixture of the non-coat ferrite carrier and the magnetic powder as a sample by a suction-type charged amount meter (210HS-2A, by Trek Co.).

TABLE 1

| | Concentration | pH value of | Time of | | Average | Frictional |
|---|---|---|---|---|---|---|
| | of | ferrous | oxidation | Shape of | particle | charged |
| Magnetic | Na₃PO₄ | salt | reaction | magnetic | diameter | amount |
| powder | (mol/l) | solution | (min.) | powder | (μm) | (μC/g) |
| A | 0.20 | 10 | 120 | Octahedron | 0.20 | −15.4 |
| B | 0.20 | 10 | 150 | Octahedron | 0.25 | −14.1 |
| C | 0.20 | 10 | 80 | Octahedron | 0.16 | −17.3 |
| D | 0.10 | 10 | 120 | Octahedron | 0.20 | −10.2 |
| E | 0.30 | 10 | 120 | Octahedron | 0.20 | −20.3 |
| F | 0.20 | 10 | 160 | Octahedron | 0.26 | −13.6 |
| G | 0.20 | 10 | 70 | Octahedron | 0.15 | −17.8 |
| H | 0.09 | 10 | 120 | Octahedron | 0.20 | −9.9 |
| I | 0.22 | 10 | 120 | Octahedron | 0.20 | −20.5 |
| J | 0.20 | 8 | 120 | Hexahedron | 0.20 | −15.4 |
| K | 0.20 | 6 | 120 | Sphere | 0.20 | −15.4 |

It is understood from Table 1 that the frictional charged amount of the magnetic powder with non-coat ferrite carrier can be adjusted by controlling the amount of phosphoric acid salt (Na₃PO₄) used when producing the magnetic powder and/or the particle diameter of the magnetic powder.

### Preparation Example 2

### Preparation of Polyester Resin

A four-necked flask of volume 2 L equipped with a thermometer, a stainless steel stirrer, a nitrogen-introducing glass tube, and a flow-down type condenser was used as a reaction container. Ethylene glycol of 55% by mole, terephthalic acid of 35% by mole, and 1,2,4-benzene tricarboxylic acid anhydride of 10% by mole were respectively introduced into the reaction container. The reaction container was placed on a mantle heater, and the atmosphere in the reaction container was made inert by introducing nitrogen gas into the reaction container from the nitrogen-introducing glass tube. Then, the temperature inside the reaction container was raised to 220° C. while stirring the mixture of the monomers to allow a polymerization reaction at the same temperature while continuing the stirring. During the polymerization reaction, a small amount of resin in the reaction container was sampled to measure an acid value, and the polymerization reaction was stopped when the acid value had reached 5 mgKOH/g. The content in the reaction container was taken out onto a stainless tray to allow cooling to room temperature, thereby obtaining a polyester resin.

### Examples 1 to 9 and Comparative Examples 1 to 6

Using the magnetic powders and the silica fine particles, of which type and amount are described in Tables 2 to 4, and performing melting and kneading at the temperatures described in Tables 2 to 4, positively chargeable magnetic toners of Examples 1 to 9 and Comparative Examples 1 to 6 were obtained. Specific production processes of the toners were as follows.

50% by mass of the polyester resin prepared in Preparation Example 2, 3% by mass of a positively chargeable charge control agent (FCA-207P, by Fujikurakasei Co.), 1% by mass of a positively chargeable charge control agent (BONTRON N-07, by Orient Chemical Industries Co.), 43% by mass of magnetic powders of which types are described in Tables 2 to 4, and 3% by mass of a release agent (Carnauba wax, by S. Kato. & Co.) were mixed using a HENSCHEL MIXER (FM-20, by Nippon Coke & Engineering Co.) for 5 minutes under a condition of rotation number 2,000 rpm. The resulting mixtures were melted and kneaded using a twin screw extruder (PCM-30, by Ikegai Co.) at the melting/kneading temperatures (cylinder temperatures) described in Tables 2 to 4 under a condition of rotation number 180 rpm and treating speed 100 g/min. The resulting melt-kneaded materials were coarsely pulverized into about 2 mm by a ROTOPLEX MILL (by Alpine Co.), and then the resulting coarsely pulverized materials were finely pulverized by a mechanical mill (turbo mill T250, by Freund-Turbo Co.). The resulting finely pulverized materials were classified by a wind classifier (Model EJ-L3, by Nittetsu Mining Co.), thereby obtaining toner base particles with an average particle diameter of 7 μm.

100 parts by mass of the resulting toner base particles, silica fine particles (RA 200, by Japan Aerosil Co.) of the amounts described in Tables 2 to 4, and 0.3 part by mass of titanium oxide (EC-100, by Titan Kogyo, Ltd.) were mixed using the HENSCHEL MIXER for 10 minutes under a condition of rotation number 2,000 rpm, thereby obtaining the toners of

### Examples 1 to 9 and Comparative Examples 1 to 6

### Measurement of Physical Properties

The toners of Examples 1 to 9 and Comparative Examples 1 to 6 were measured for a particle number of the magnetic powder exposed on toner surface per 1 μm² area of the toner in an electron microscope image (number of exposed particles in magnetic powder (number/μm²), a ratio (%) of an area (Ae) of external additive versus an area (At) of toner in an electron microscope image (area ratio of external additive/toner (%)), and an average particle diameter (DW_{AV}) of particles of release agent dispersed in the binder resin in accordance with the methods below. The results of the measurement items of the toners of Examples 1 to 9 and Comparative Examples 1 to 6 are shown in Tables 2 to 4.

Method of Measuring Number of Exposed Particles in Magnetic Powder (number/μm²)

A secondary electron photographic image (SEM image, magnification: 30,000 times) of toner particles was taken using a scanning electron microscope (SEM) (JSM-7600, by Jeol Ltd.). The taken SEM image was subjected to automatic binarization treatment (mode: P-tile) using the image analysis software (WINROOF, by Mitani Co.). 100 toner particles at random in the binarization-treated SEM image were respectively measured for an area (At (μm²)) of a toner particle in the SEM image. The 100 toner particles, measured for an area (At) of each toner particle, were respectively measured for a particle number (Nm (number)) of the magnetic powder exposed on a surface of one toner particle. The 100 toner particles were respectively calculated for Nm (number)/At (μm²) from At (μm²) and Nm (number). An average value of Nm (number)/At (μm²) of the 100 toner particles was defined as a particle number of the magnetic powder exposed on toner surface per 1 μm² area of the toner in an electron microscope image (number of exposed particles in magnetic powder (number/μm²)).

### Method of Measuring Area Ratio of External Additive/Toner (%)

A secondary electron photographic image (SEM image, magnification: 30,000 times) of toner particles was taken using a scanning electron microscope (SEM) (JSM-7600, by Jeol Ltd.). The taken SEM image was subjected to automatic binarization treatment (mode: P-tile) using the image analysis software (WINROOF, by Mitani Co.). 100 toner particles at random in the binarization-treated SEM image were respectively measured for an area (At) of a toner particle and an area (Ae) of the external additive attaching to a surface of the toner particle. Then, the ratio (Ae/At (%)) of the area (Ae) of the external additive versus the area (At) of the toner particle was calculated. An average value of Ae/At (%) obtained respectively for 100 toner particles was defined as the area ratio of external additive/toner (%) of the toner of a measurement sample.

### Method of Measuring DW_{AV}

A sample where a toner had been embedded in a resin was prepared. Using a microtome (Leica Ultracut S, by Leica Co.), a thin-piece sample of 200 nm thick for observing a toner cross-section was prepared from the resulting sample. The resulting thin-piece sample was observed using a transmission electron microscope function (STEM mode) of the electron microscope (JSM-7600, by Jeol Ltd.) at a magnification from 10,000 to 30,000 times; and among particles of the release agent dispersed in the binder resin, images of randomly selected 100 particles were taken to measure a particle diameter of the particles of the release agent. The taken images were analyzed by an image analysis software (WINROOF, by Mitani Co.), and a Martin diameter (equivalent circle diameter) of a particle to be measured was defined as a particle diameter of the release agent. An average value of particle diameters of 100 particles of the release agent to be measured was defined as DW_{AV}.

### Evaluation

Evaluation of occurrence of filming, evaluation of image density, and evaluation of occurrence of layer unevenness were performed using the toners of Examples 1 to 9 and Comparative Examples 1 to 6 in accordance with the methods below. The results of the evaluation of occurrence of filming, the evaluation of image density, and the evaluation of occurrence of layer unevenness for the toners of Examples 1 to 9 and Comparative Examples 1 to 6 are shown in Tables 2 to 4. A printer equipped with a developing unit having a developing roller whose surface had been plated with chrome (modified type of FS-1370DN (by KYOCERA Document Solutions Inc.) of which developing roller had been changed to a developing roller plated with chrome) was used as an evaluation apparatus. After the toners were filled into a toner container, a toner of Examples 1 to 9 or Comparative Examples 1 to 6 was filled into the developing unit. Here, the chromizing on the developing roller provided to the printer was applied in accordance with the procedure below. In addition, the image density was measured using a reflection density meter (TC-6DS, by Tokyo Denshoku Co.) and the image density at about a center of a solid image was measured.

### Method of Chromizing

A developing roller was pulled out from the developing unit of the printer (FS-1370DN, by KYOCERA Document Solutions Inc.) and a surface of the developing roller was rinsed with deionized distilled water. Then, a nonelectrolytic nickel plating was applied on the rinsed surface of the developing roller to thereby form a nickel plated layer (thickness: 50 μm). Then, an electrolytic plating was applied on the nickel plated layer formed on the surface of the developing roller to thereby form a chrome plated layer (thickness: 10 μm).

### Evaluation of Occurrence of Filming

An image was continuously formed on a recording medium at a coverage rate of 4%; and a solid image of 2.5 cm by 2.5 cm was formed on the recording medium per every 10,000 sheets to measure an image density of the solid image. When the image density was no greater than 1.0 and also fixation of toner components was visually confirmed on the developing roller of the evaluation apparatus, it was determined that filming had occurred. The number of sheets of the image with the coverage rate of 4% formed until immediately before the occurrence of filming is shown in Tables 3 and 4. Suppression of the occurrence of filming was evaluated on the basis of the criteria below.

Good (pass): number of sheets of the image with the coverage rate of 4% formed until immediately before the occurrence of filming is no less than 100,000; and

Bad (non-pass): number of sheets of the image with the coverage rate of 4% formed until immediately before the occurrence of filming is less than 100,000.

### Evaluation of Image Density

Initially, a solid image of 2.5 cm by 2.5 cm was formed on a recording medium, and a density of the solid image was measured as the image density of an initial image.

Thereafter, after allowing the evaluation apparatus to stand under an environment of 30° C. and 80% RH for 24 hours, an image was continuously formed on 5,000 sheets of a recording medium at a coverage rate of 1%. Thereafter, a solid image of 2.5 cm by 2.5 cm was formed on the recording medium, and density of the solid image was measured as the image density of an image after forming 5,000 sheets of the image. Image densities of the initial image and the image after forming 5,000 sheets of the image were evaluated on the basis of the criteria below.

Good (pass): image density is no less than 1.1; and

Bad (non-pass): image density is less than 1.1.

### (Evaluation of Occurrence of Layer Unevenness)

When thickness of toner thin layers carried on a developing sleeve is uneven, a portion with a thicker toner layer is formed on developing sleeves (surface of developing rollers). In this case, fog is formed on a white paper by a cycle of the developing sleeve resulting from the portion with a thicker toner layer. Therefore, after allowing the evaluation apparatus to stand under an environment of 10° C. and 20% RH for 24 hours, an image was continuously formed on 5,000 sheets of a recording medium at a coverage rate of 1%. Thereafter, a white paper image was formed on a recording medium, and a fog density of the white paper image was measured.

The fog density was determined as a difference between an image density at the site where the resulting image density of the white paper image was highest and an image density of base paper (recording medium before image formation). Occurrence of layer unevenness was evaluated on the basis of the criteria below. The evaluation criteria were defined in consideration that thickness of toner thin layers carried on the developing roller of the evaluation apparatus has become uneven when the fog density is no less than 0.01.

Good (pass): fog density of white paper image is less than 0.01; and

Bad (non-pass): fog density of white paper image is no less than 0.01.

### Reference Example

As a reference example, the evaluation apparatus was changed to an un-modified printer (FS-1370DN, by KYOCERA Document Solutions Inc.), and the evaluation of occurrence of filming, the evaluation of image density, and the evaluation of occurrence of layer unevenness were performed using the toner of Example 1. The results of the evaluation of occurrence of filming, the evaluation of image density, and the evaluation of occurrence of layer unevenness in Reference Example are shown in Table 3.

Here, with respect to the evaluation of occurrence of layer unevenness in Reference Example, image formation was continuously performed at a coverage rate of 1% in succession to the image formation of 5,000 sheets at a coverage rate of 1%, and then a white paper image was formed after every printing of 5,000 sheets and fog density of the white paper image was measured. As a result, in Reference Example, fog did not occur in the white paper image until image formation of 50,000 sheets in total.

TABLE 2

| | | Example | | | | |
|---|---|---|---|---|---|---|
| | | 1 | 2 | 3 | 4 | 5 |
| Magnetic | Type | A | B | C | D | E |
| powder | Shape | Octahedron | Octahedron | Octahedron | Octahedron | Octahedron |
| | Particle | 0.20 | 0.25 | 0.16 | 0.20 | 0.20 |
| | Diameter (μm) | | | | | |
| | Particle number | 8.4 | 3.8 | 12.4 | 8.8 | 8.5 |
| | of the magnetic | | | | | |
| | powder exposed | | | | | |
| | (number/μm) | | | | | |
| | Charged amount | −15.4 | −14.1 | −17.3 | −10.2 | −20.3 |
| | (μC/g) | | | | | |

| | | | | | |
|---|---|---|---|---|---|
| Temperature of | 120 | 120 | 120 | 120 | 120 |
| melting/kneading (° C.) | | | | | |
| Average particle diameter | 0.4 | 0.4 | 0.4 | 0.4 | 0.4 |
| of release agent (DW_{AV}) | | | | | |
| (μm) | | | | | |
| Used amount of silica | 0.6 | 0.6 | 0.6 | 0.6 | 0.6 |
| (parts by mass) | | | | | |
| Area ratio of external | 45 | 45 | 45 | 45 | 45 |
| additive/toner | | | | | |
| (%) | | | | | |
| Evaluation | | | | | |
| Number of sheets | 110000/ | 100000/ | 120000/ | 110000/ | 110000/ |
| printed until immediately | Good | Good | Good | Good | Good |
| before the occurrence of | | | | | |
| filming/ | | | | | |
| Evaluation | | | | | |
| Image density initial | 1.25/ | 1.22/ | 1.24/ | 1.26/ | 1.20/ |
| image/ | Good | Good | Good | Good | Good |
| Evaluation | | | | | |
| Image density after | 1.20/ | 1.19/ | 1.14/ | 1.23/ | 1.15/ |
| printing of 5000 sheets | Good | Good | Good | Good | Good |
| under a high temperature and | | | | | |
| high humidity environment/ | | | | | |
| Evaluation | | | | | |
| Layer unevenness | Good | Good | Good | Good | Good |

TABLE 3

| | | Example | | | |
|---|---|---|---|---|---|
| | | 6 | 7 | 8 | 9 |
| Magnetic | Type | A | A | A | A |
| powder | Shape | Octahedron | Octahedron | Octahedron | Octahedron |
| | Particle | 0.20 | 0.20 | 0.20 | 0.20 |
| | Diameter (μm) | | | | |
| | Particle number | 8.4 | 8.4 | 8.4 | 8.4 |
| | of the magnetic | | | | |
| | powder exposed | | | | |
| | (number/μm²) | | | | |
| | Charged amount | −15.4 | −15.4 | −15.4 | −15.4 |
| | (μC/g) | | | | |

| | | | | |
|---|---|---|---|---|
| Temperature of | 120 | 120 | 100 | 70 |
| melting/kneading (° C.) | | | | |
| Average particle diameter | 0.4 | 0.4 | 0.3 | 0.1 |
| of release agent (DM_{AV}) | | | | |
| (μm) | | | | |
| Used amount of silica | 0.4 | 0.75 | 0.6 | 0.6 |
| (parts by mass) | | | | |
| Area ratio of external | 31 | 60 | 45 | 45 |
| additive/toner | | | | |
| (%) | | | | |
| Evaluation | | | | |
| Number of sheets | 120000/ | 100000/ | More than 150000/ | More than 150000/ |
| printed until immediately | Good | Good | Good | Good |
| before the occurrence of | | | | |
| filming/ | | | | |
| Evaluation | | | | |
| Image density of initial | 1.17/ | 1.31/ | 1.25/ | 1.26/ |
| image/ | Good | Good | Good | Good |
| Evaluation | | | | |
| Image density after | 1.13/ | 1.27/ | 1.21/ | 1.20/ |
| printing of 5000 sheets | Good | Good | Good | Good |
| under a high temperature and | | | | |
| high humidity environment/ | | | | |
| Evaluation | | | | |
| Layer unevenness | Good | Good | Good | Good |

TABLE 4

| | | Comparative example | | | | | | Reference |
|---|---|---|---|---|---|---|---|---|
| | | 1 | 2 | 3 | 4 | 5 | 6 | example |
| Magnetic | Type | F | G | H | I | J | K | A |
| powder | Shape | Octahedron | Octahedron | Octahedron | Octahedron | Hexahedron | Sphere | Octahedron |
| | Particle | 0.26 | 0.15 | 0.20 | 0.20 | 0.20 | 0.20 | 0.20 |
| | Diameter (μm) | | | | | | | |
| | Particle | 3.1 | 13.3 | 8.2 | 8.3 | 8.6 | 8.5 | 8..4 |
| | number of the | | | | | | | |
| | magnetic | | | | | | | |
| | powder exposed | | | | | | | |
| | (number/μm) | | | | | | | |
| | Charged amount | −13.6 | −17.8 | −9.9 | −20.5 | −15.4 | −15.4 | −15.4 |
| | (μC/g) | | | | | | | |

| | | | | | | | |
|---|---|---|---|---|---|---|---|
| Temperature of | 120 | 120 | 120 | 120 | 120 | 120 | 120 |
| melting/kneading (° C.) | | | | | | | |
| Average particle diameter | 0.4 | 0.4 | 0.4 | 0.4 | 0.4 | 0.4 | 0.4 |
| of release agent (DW_{AV}) | | | | | | | |
| (μm) | | | | | | | |
| Used amount of silica | 0.6 | 0.6 | 0.6 | 0.6 | 0.6 | 0.6 | 0.6 |
| (parts by mass) | | | | | | | |
| Area ratio of external | 45 | 45 | 45 | 45 | 45 | 45 | 45 |
| additive/toner | | | | | | | |
| (%) | | | | | | | |
| Evaluation | | | | | | | |
| Number of sheets | 70000/ | 130000/ | 110000/ | 110000/ | 60000/ | 40000/ | More than |
| printed until immediately | Bad | Good | Good | Good | Bad | Bad | 150000/ |
| before the occurrence of | | | | | | | Good |
| filming/ | | | | | | | |
| Evaluation | | | | | | | |
| Image density of initial | 1.21/ | 1.24/ | 1.27/ | 1.17/ | 1.27/ | 1.28/ | 1.25/ |
| image/ | Good | Good | Good | Good | Good | Good | Good |
| Evaluation | | | | | | | |
| Image density after | 1.18/ | 1.08/ | 1.24/ | 1.07/ | 1.24/ | 1.26/ | 1.20/ |
| printing of 5000 sheets | Good | Bad | Good | Bad | Good | Good | Good |
| under a high temperature and | | | | | | | |
| high humidity environment/ | | | | | | | |
| Evaluation | | | | | | | |
| Layer unevenness | Good | Good | Bad | Good | Good | Good | Good |

It is understood from Examples 1 to 9 that, by using the toners which include a binder resin and an octahedral magnetic powder of convex polyhedron enclosed by eight triangles in which the frictional charged amount of the magnetic powder with ferrite carrier is −20.3 μC/g or more and −10.2 μC/g or less and the number of exposed particles in magnetic powder is 4 or more and 12 or less (number/μm²), the occurrence of filming can be suppressed, the images with an intended image density can be formed even under high temperature and high humidity environments, and the tendency to uneven thickness of toner thin layers carried on the developing sleeve can be suppressed under low temperature and low humidity environments.

It is understood from Comparative Example 1 that the occurrence of filming is unlikely to be suppressed when using a toner with an excessively small number of exposed particles in the magnetic powder. The reason is considered that the magnetic powder exposed on the toner surface cannot sufficiently polish the surface of the developing roller.

It is understood from Comparative Example 2 that the images with an intended image density are unlikely to be formed under high temperature and high humidity environments when using a toner with an excessively large number of exposed particles in the magnetic powder. The reason is considered that electric discharge tends to occur from the ridge lines and/or vertices of the magnetic powder exposed on the toner surface and thus the charged state of the toner is likely to be unstable under high temperature and high humidity environments.

It is understood from Comparative Example 3 that the thickness of toner thin layer carried on the developing sleeve (surface of developing roller) is likely to be uneven when forming images under low temperature and low humidity environments in cases of using a toner containing the magnetic powder of which frictional charged amount with ferrite carrier is greater than −10.2 μC/g. The reason is considered that the charged state of the toner tends to be unstable under low temperature and low humidity environments.

It is understood from Comparative Example 4 that images with an intended image density are unlikely to be formed under high temperature and high humidity environments in cases of using a toner containing the magnetic powder of which frictional charged amount with ferrite carrier is less than −20.3 μC/g. The reason is considered that the charged state of the toner tends to be unstable under high temperature and high humidity environments.

It is understood from Comparative Example 5 that the occurrence of filming is unlikely to be suppressed in cases of using a toner containing the magnetic powder of which particle shape is hexahedral. It is believed that filming can be suppressed by action of ridge line portions of the magnetic powder exposed on the toner surface to polish the surface of the developing sleeve. In this regard, the number of ridge lines of hexahedral magnetic powder is less than that of octahedral magnetic powder. For this reason, it is believed that the surface of the developing sleeve cannot be sufficiently polished and thus the filming has occurred when using a toner containing the hexahedral magnetic powder with less number of ridge lines.

It is understood from Comparative Example 6 that, in cases of using a toner containing the magnetic powder of which particle shape is spherical, the occurrence of filming is further unlikely to be suppressed compared to the case of using a toner containing the hexahedral magnetic powder. The reason is considered that the hexahedral magnetic powder has some ridge lines and exhibits a polishing effect although being insufficient; on the other hand, the spherical magnetic powder exhibits almost no polishing effect due to no ridge line.

1. A positively chargeable magnetic toner, comprising at least a binder resin and a magnetic powder, wherein
a particle shape of the magnetic powder is an octahedron which is a convex polyhedron enclosed by eight triangles,
a frictional charged amount of the magnetic powder with ferrite carrier is −20.3 μC/g or more and −10.2 μC/g or less, and
a particle number of the magnetic powder exposed on a surface of the positively chargeable magnetic toner, per 1 μm² area of the positively chargeable magnetic toner, is 4 or more and 12 or less in an electron microscope image of the positively chargeable magnetic toner.

2. The positively chargeable magnetic toner according to claim 1, wherein the surface of the positively chargeable magnetic toner is coated with an external additive, and
an area ratio (%) of external additive/toner, which is a ratio (Ae/At) of an area (Ae) of the external additive adhering to the toner surface versus an area (At) of the toner in an electron microscope image, is 30% or higher and 60% or lower.

3. The positively chargeable magnetic toner according to claim 1, further comprising a release agent, and wherein
an average particle diameter of the release agent in the binder resin is no greater than 0.3 μm.

4. The positively chargeable magnetic toner according to claim 1, wherein an average particle diameter of the magnetic powder is 0.16 μm or larger and 0.25 μm or smaller.

5. An image forming method, comprising forming an image using the positively chargeable magnetic toner according to claim 1, and using an image forming apparatus equipped with a developing unit equipped with a developing roller whose surface has been plated with chrome.
